(19) United States
(12) Patent Application Publication
(10) Pub. No.: US 2014/0169664 A1
(43) Pub. Date: Jun. 19, 2014

(54) APPARATUS AND METHOD FOR RECOGNIZING HUMAN IN IMAGE

(71) Applicant: Electronics and Telecommunications Research Institute, Daejeon-city (KR)

(72) Inventors: Byung-Gil HAN, Daegu (KR); Yun-Su CHUNG, Daejeon (KR); Kil-Taek LIM, Daegu (KR); Eun-Chang CHOI, Daejeon (KR); Soo-In LEE, Daejeon (KR)

(73) Assignee: Electronics and Telecommunications Research Institute, Daejeon-city (KR)

(21) Appl. No.: 13/959,288

(22) Filed: Aug. 5, 2013

(30) Foreign Application Priority Data
Dec. 17, 2012 (KR) 10-2012-0147206

(51) Int. Cl. G06K 9/00

(52) U.S. Cl. CPC G06K 9/00362
USPC 382/159

(57) ABSTRACT

Disclosed herein are an apparatus and method for recognizing a human in an image. The apparatus includes a learning unit and a human recognition unit. The learning unit calculates a boundary value between a human and a non-human based on feature candidates extracted from a learning image, detects a feature candidate for which an error is minimized as the learning image is divided into the human and the non-human using the calculated boundary value, and determines the detected feature candidate to be a feature. The human recognition unit extracts a candidate image where a human may be present from an acquired image, and determines whether the candidate image corresponds to a human based on the feature that is determined by the learning unit.

### CROSS REFERENCE TO RELATED APPLICATION

This application claims the benefit of Korean Patent Application No. 10-2012-0147206, filed on Dec. 17, 2012, which is hereby incorporated by reference in its entirety into this application.

### BACKGROUND OF THE INVENTION

1. Technical Field

The present invention relates to an apparatus and method for recognizing a human in an image and, more particularly, to an apparatus and method that are capable of recognizing a human in an image, such as a closed-circuit television (CCTV) image.

2. Description of the Related Art

Technology for recognizing human information in a digital image acquired from a charge coupled device (CCD), a complementary metal-oxide semiconductor (CMOS), an infrared sensor, or the like is widely used in the user authentication of a security and surveillance system, digital cameras, entertainment, etc.

In particular, a technology for recognizing a human using a digital image is a non-contact method that does not require strong coercion in order to acquire information, unlike recognition technologies using other types of biometric information, such as a fingerprint, an iris, etc., and thus has attracted attention thanks to the advantages of not incurring a user's repulsion or inconvenience.

However, in spite of these advantages, the technology for recognizing a human using a digital image is problematic in that acquired information is not uniform and there is a strong possibility of distortion in an input image because of changes in illustration, changes in the size of an object to be recognized, or the like because it is a non-contact method.

In order to overcome these problems, a feature-based classification method that searches for a feature capable of identifying a recognition target best using previous information under various conditions and that performs classification to recognize the recognition target based on the feature is widely used.

The most important requirement of the feature-based classification method is to solve how the feature of a recognition target can be represented and what feature can identify a recognition target best.

Korean Patent No. 10-1077312 discloses an apparatus and method for detecting a human using Haar-like feature points, which can automatically detect the presence of an object of interest using Haar-like feature points in real time and keep track of the object of interest, thereby actively replacing a human's role. The technology disclosed in the above-described Korean Patent No. 10-1077312 includes a preprocessing unit configured to smooth an input image so that it is not sensitive to illuminance and external environments, a candidate region determination unit configured to determine a candidate region by extracting a feature point from an input image based on Haar-like feature points using an AdaBoost learning algorithm and then comparing the extracted feature point with candidate region feature points stored in a candidate region feature point database, and an object determination unit configured to determine an object based on a candidate region determined by the candidate region determination unit.

However, the technology disclosed in the above-described Korean Patent No. 10-1077312 merely uses an existing AdaBoost method without modification.

### SUMMARY OF THE INVENTION

Accordingly, the present invention has been made keeping in mind the above problems occurring in the conventional art, and an object of the present invention is to provide an apparatus and method for recognizing a human in an image, which searches for a robust human feature and recognizes a human based on the found feature.

In accordance with an aspect of the present invention, there is provided an apparatus for recognizing a human in an image, including a learning unit configured to calculate a boundary value between a human and a non-human based on feature candidates extracted from a learning image, to detect a feature candidate for which an error is minimized as the learning image is divided into the human and the non-human using the calculated boundary value, and to determine the detected feature candidate to be a feature; and a human recognition unit configured to extract a candidate image where a human may be present from an acquired image, and to determine whether the candidate image corresponds to a human based on the feature that is determined by the learning unit.

The learning unit may include a feature candidate extraction unit configured to extract the feature candidates that can be represented by the feature of the human from the learning image; a boundary value calculation unit configured to calculate the boundary value that can divide the learning image into a human and a non-human based on the extracted feature candidates; a minimum error detection unit configured to detect the feature candidate for which the error is minimized as the learning image is divided into the human and the non-human using the calculated boundary value, among the feature candidates; and a feature determination unit configured to determine the detected feature candidate to be the feature.

The learning unit may further include a weight change unit configured to change a weight while taking into account an error of each of the feature candidates that is calculated by the minimum error detection unit.

If the weights of the feature candidates are changed by the weight change unit, the learning unit may search again for a feature candidate for which an error is minimized based on the changed weights, and may determine this feature candidate to be the feature.

The human recognition unit may include a candidate image extraction unit configured to extract a candidate image of a region where a human may be present from the acquired image; a feature extraction unit configured to extract a feature from the extracted candidate image; a feature comparison unit configured to compare the feature extracted from the candidate image with the feature determined by the learning unit; and a determination unit configured to determine whether the extracted candidate image corresponds to a human based on the results of the comparison of the feature comparison unit.

The apparatus may further include a preprocessing unit configured to preprocess the acquired image and to transfer results of the preprocessing to the human recognition unit.

The acquired image may be a digital image.

In accordance with an aspect of the present invention, there is provided a method of recognizing a human in an image, including calculating, by a learning unit, a boundary value between a human and a non-human based on feature candidates extracted from a learning image; detecting, by the learning unit, a feature candidate for which an error is minimized as the learning image is divided into the human and the non-human using the calculated boundary value, and determining, by the learning unit, the detected feature candidate to be a feature; extracting, by a human recognition unit, a candidate image where a human may be present from an acquired image; and determining, by the human recognition unit, whether the candidate image corresponds to a human based on the determined feature.

The calculating the boundary value learning may include extracting the feature candidates that can be represented by the feature of the human from the learning image; and calculating the boundary value that can divide the learning image into a human and a non-human based on the extracted feature candidates.

The boundary value may be determined using a Support Vector Machine (SVM) method.

Determining whether the candidate image corresponds to a human may include extracting a feature from the extracted candidate image; comparing the feature extracted from the candidate image with the determined feature of the learning image; and determining whether the extracted candidate image corresponds to a human based on results of the comparison.

The method may further include preprocessing the acquired image and transferring the results of the preprocessing for use in the extraction of the candidate image.

The acquired image may be a digital image.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating the configuration of an apparatus for recognizing a human in an image according to an embodiment of the present invention;

FIG. 2 is a diagram illustrating the internal configuration of the learning unit illustrated in FIG. 1;

FIG. 3 is a diagram illustrating the internal configuration of the human recognition unit illustrated in FIG. 1; and

FIG. 4 is a flowchart illustrating a method of recognizing a human in an image according to an embodiment of the present invention.

### DESCRIPTION OF THE PREFERRED EMBODIMENTS

An apparatus and method for recognizing a human in an image according to embodiments of the present invention will be described with reference to the accompanying drawings below. Prior to the detailed description of the present invention, it should be noted that the terms and words used in the specification and the claims should not be construed as being limited to ordinary meanings or dictionary definitions. Meanwhile, the embodiments described in the specification and the configurations illustrated in the drawings are merely examples and do not exhaustively present the technical spirit of the present invention. Accordingly, it should be appreciated that there may be various equivalents and modifications that can replace the examples at the time at which the present application is filed.

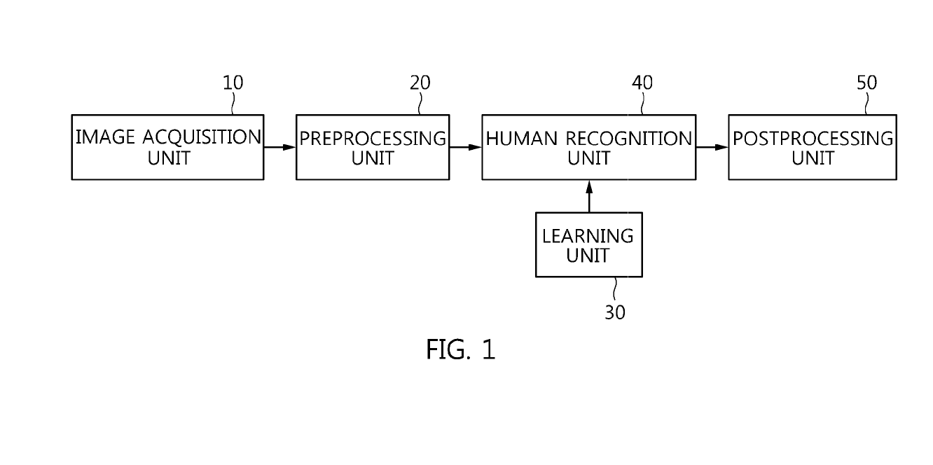

FIG. 1 is a diagram illustrating the configuration of an apparatus for recognizing a human in an image according to an embodiment of the present invention.

The apparatus for recognizing a human in an image according to this embodiment of the present invention includes an image acquisition unit 10, a preprocessing unit 20, a learning unit 30, a human recognition unit 40, and a postprocessing unit 50.

The image acquisition unit 10 acquires an image in which a human will be recognized. Preferably, the image acquisition unit 10 acquires a digital image in which a human will be recognized via an image acquisition device, such as a CCTV camera. For example, the acquired digital image may be a color image, a monochrome image, an infrared image or the like, and may be a still image or a moving image.

The preprocessing unit 20 performs preprocessing on the image acquired by the image acquisition unit 10 before transferring it to the human recognition unit 40. More specifically, the preprocessing unit 20 eliminates noise that may influence recognition performance, and converts the acquired image into a unified image format. Furthermore, the preprocessing unit 20 changes the size of the image at a specific rate based on the size of an object to be recognized. As described above, the preprocessing unit 20 changes the size, color space and the like of the image that is acquired by the image acquisition unit 10.

The learning unit 30 learns a classifier that is used by the human recognition unit 40. The details of the learning unit 30 will be described later.

The human recognition unit 40 receives the image from the preprocessing unit 20 and a feature from the learning unit 30, and recognizes a human using the feature-based classifier. The details of the human recognition unit 40 will be described later.

The postprocessing unit 50 performs postprocessing on the results of the recognition that are obtained by the human recognition unit 40 so that they can be used for the input image. That is, the postprocessing unit 50 finally processes the results of the recognition obtained by the human recognition unit 40 so that they are suitable for their purpose. For example, the postprocessing unit 50 may calculate the actual location of a human recognized in the original input image while taking into account the rate at which the size of the image was changed by the preprocessing unit 20.

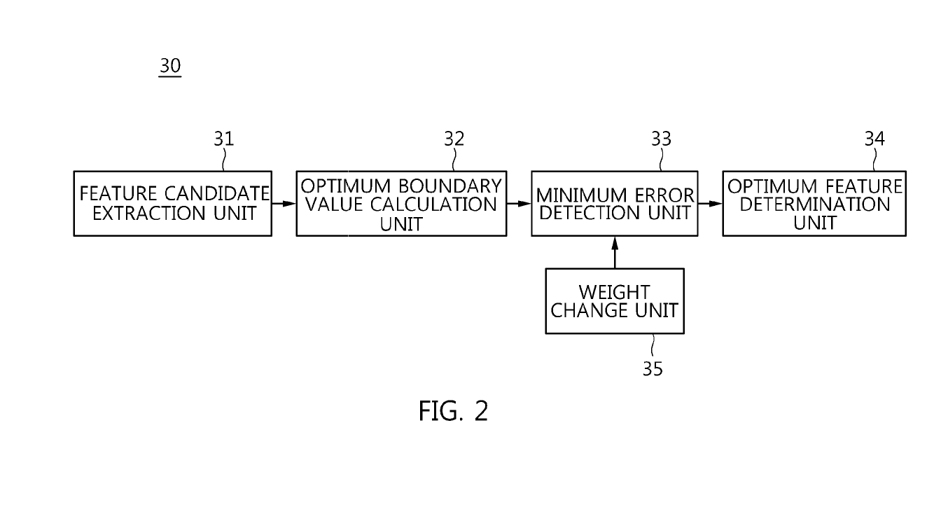

FIG. 2 is a diagram illustrating the internal configuration of the learning unit illustrated in FIG. 1.

The learning unit 30 includes a feature candidate extraction unit 31, an optimum boundary value calculation unit 32, a minimum error detection unit 33, an optimum feature determination unit 34, and a weight change unit 35.

The feature candidate extraction unit 31 extracts feature candidates from a learning image. That is, the feature candidate extraction unit 31 extracts all candidates that can be represented by the feature of a human (that is, feature candidates) from the learning image for which information about a human has been known. For example, if the width of the learning image is W and the height thereof is H, the number N of all cases that can be represented by the feature of the human is calculated by the following Equation 1:

$$N = {\sum }_{w = 1}^{W} w \times {\sum }_{h = 1}^{H} h \qquad ( 1 )$$

In Equation 1, a capital “W” represents the width of the learning image, a capital “H” represents the height of the learning image, and a small “w” and a small “h” represent regions indicative of the feature candidates of the human. That is, Equation 1 represents the number N of all cases that can be represented by (w, h).

The optimum boundary value calculation unit 32 calculates an optimum boundary value that can divide a human and a non-human based on the feature candidates extracted from the learning image. That is, the optimum boundary value calculation unit 32 calculates an optimum boundary value that can divide the learning image into a human and a non-human best based on the N feature candidates extracted by the feature candidate extraction unit 31. The optimum boundary value calculation unit 32 is an example of a boundary value calculation unit that is described in the claims of this application.

The minimum error detection unit 33 searches for a feature candidate for which a cumulative error is minimized when classification is performed using the optimum boundary value calculated by the optimum boundary value calculation unit 32. That is, the minimum error detection unit 33 extracts a feature candidate for which a cumulative error is minimized when a learning image is divided into a human and a non-human using the optimum boundary value calculated by the optimum boundary value calculation unit 32.

The optimum feature determination unit 34 determines an optimum feature based on the results of the minimum error detection unit 33. That is, the optimum feature determination unit 34 determines a feature candidate for which an error is minimized to be a feature that represents a human best, and stores it for use in the human recognition unit 40. The optimum feature determination unit 34 is an example of a feature determination unit that is described in the claims of this application.

The weight change unit 35 changes the weight of the feature candidate in order to search for a new optimum feature. That is, the weight change unit 35 changes the weight while taking into account the error of the feature candidate calculated by the minimum error detection unit 143. Meanwhile, when the weight is changed, a task is repeated in which the minimum error detection unit 33 searches for a feature candidate for which an error is minimized using the changed weight and the optimum feature determination unit 34 determines the feature candidate to be an optimum feature.

The above-described learning unit 30 calculates a boundary value between a human and a non-human based on feature candidates extracted from the learning image, and distinguishes the human and the non-human using the calculated boundary value, thereby detecting a feature candidate for which the error is minimized among the feature candidates and determining the detected candidate to be a feature.

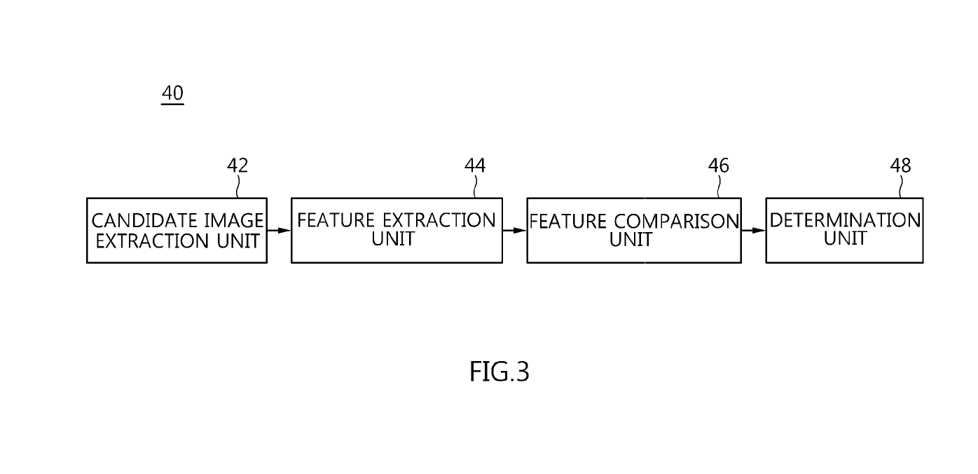

FIG. 3 is a diagram illustrating the internal configuration of the human recognition unit illustrated in FIG. 1.

The human recognition unit 40 includes a candidate image extraction unit 42, a feature extraction unit 44, a feature comparison unit 46, and a determination unit 48.

The candidate image extraction unit 42 extracts a candidate image. That is, the candidate image extraction unit 42 extracts an image of a candidate region where a human may be present (that is, a candidate image) from the input image via the preprocessing unit 20. For example, since in most cases it is difficult to know the region of an input image where a human is present, the candidate image extraction unit 42 extracts images of all regions of the input image as candidate images. However, if a candidate region can be predicted, a candidate image is extracted from the predicted candidate region.

The feature extraction unit 44 extracts the feature, determined via learning, from the candidate image. That is, the feature extraction unit 44 extracts the feature, determined to be the optimum feature by the learning unit 30, from the candidate image that is extracted by the candidate image extraction unit 42. In this embodiment of the present invention, an LBP histogram is used to represent the feature. The LBP histogram calculates an LBP value using the following Equation 2. In this case, the calculated 256-dimensional LBP value is converted into a 59-dimensional valid value, and the 59-dimensional value is represented using a histogram.

$${LBP}_{P , R} = {\sum }_{p = 0}^{p - 1} s ( {g}_{p} - {g}_{c} ) {2}^{p} , \\ s ( x ) = \{ \begin{matrix}1 , & if x \geq 0 ; \\ 0 , & otherwise\end{matrix} \qquad ( 2 )$$

In Equation 2, a capital “P” represents the number of points that are used to generate the LBP value. In this embodiment of the present invention, 8 points may be used. The capital “R” represents the distance from a center point. The LBP value is determined using adjacent 8 points within distance R from the center point. The small “p” represents the locations of the points from 0 up to p, which are used to calculate the LBP value. s(x) is s(gₚ−g_{c}). If x , that is, gₚ−g_{c}, is larger than 0, s(x) is 1; otherwise s(x) is 0. g_{c} represents the value of a center pixel. gₚ is the values of the adjacent 8 points compared with g_{c}, and is g0 to g7 if P is 8.

When Equation 2 is solved, the LBP value is a value in the range of 0 to 255 if P is 8.

The feature comparison unit 46 compares the feature extracted from the candidate image with the feature obtained from the results of the learning. That is, the feature comparison unit 46 compares the feature of the candidate image extracted by the feature extraction unit 44 with the optimum feature learned by the learning unit 30.

The determination unit 48 determines whether the candidate image corresponds to a human using the results of the comparison obtained by the feature comparison unit 46.

The above-described human recognition unit 40 extracts a candidate image where a human may be present from the image acquired via the image acquisition unit 10, and determines whether the candidate image corresponds to a human based on the feature of the determined learning unit 30.

In the above-described embodiment of the present invention, in order to determine an optimum feature, the learning unit 30 uses a method in which a machine learning algorithm, such as a Support Vector Machine (SVM) method, has been combined with an AdaBoost method.

The AdaBoost method is a method of finally building a strong classifier having high performance by linearly connecting one or more weak classifiers, and the optimum feature determined by the learning unit 30 corresponds to a weak classifier which belongs to weak classifiers represented by the following Equation 3 and for which an error is minimized:

$$h ( x , f , p , θ ) = \{ \begin{matrix}1 & if pf ( x ) < p θ \\ 0 & otherwise\end{matrix} \qquad ( 3 )$$

In Equation (3), a small “x” represents an input data value, and a small “f” represents a function used to obtain the feature of the input x, which is equal to f(x). θ represents a boundary value used to determine whether an image corresponds to a human, and a small “p” is a value (parity) used to determine whether a human corresponds to a value or equal to or larger than a boundary value or a value smaller than the boundary value.

In Equation 3, h(x, f, p, θ) is a weak classifier function h which is composed of four parameters, that is, x, f, p, and θ.

In Equation 3, the boundary value represented by θ is an important value that influences the performance of a weak classifier. In learning, learning is performed on the assumption that when a feature value based on a function f is calculated using learning data corresponding to a human and learning data corresponding to a non-human, the human and the non-human can be divided based on the boundary value θ. Generally, the intermediate value between the average value of learning data values corresponding to humans and the average value of learning data values corresponding to non-humans is determined to be the boundary value θ. The performance of classifiers is further improved by precisely determining the boundary value using an SVM method, rather than determining the intermediate value between the averages of respective groups to be the boundary value. An SVM method is widely used as an algorithm for finding an optimum boundary value that divides two groups. Generally, when a single classifier is used, the optimum boundary value of the classifier is found using the SVM method. In this embodiment of the present invention, the optimum boundary values of a plurality of classifier weak classifiers that are used in the AdaBoost method are found using the SVM method. If the boundary values of all the weak classifiers are found using the SVM method and then the performance thereof is improved, the performance of the strong classifier to which the weak classifiers are connected can be further improved. Accordingly, in this embodiment of the present invention, the boundary value is determined using the SVM method. In the SVM method, the determination of a decision plane is expressed by the following Equation 4:

w·x+b=0 (4)

In Equation 4, W is a conversion vector, x is an input vector (input value), and b is a constant.

The SVM method is performed in such a way that the input x is converted by W and then moved by b and W and b that become 0 are found.

According to this embodiment of the present invention, the learning unit 30 makes use of a SVM method when calculating the optimum boundary value in a process of determining the optimum feature using the existing AdaBoost AdaBoost method. As a result, the learning unit 30 combines the SVM method with the method of determining the optimum feature using the existing AdaBoost AdaBoost method, thereby being able to use a more improved boundary value. Accordingly, the learning unit 30 can determine an optimum feature that is more effective in recognizing a human.

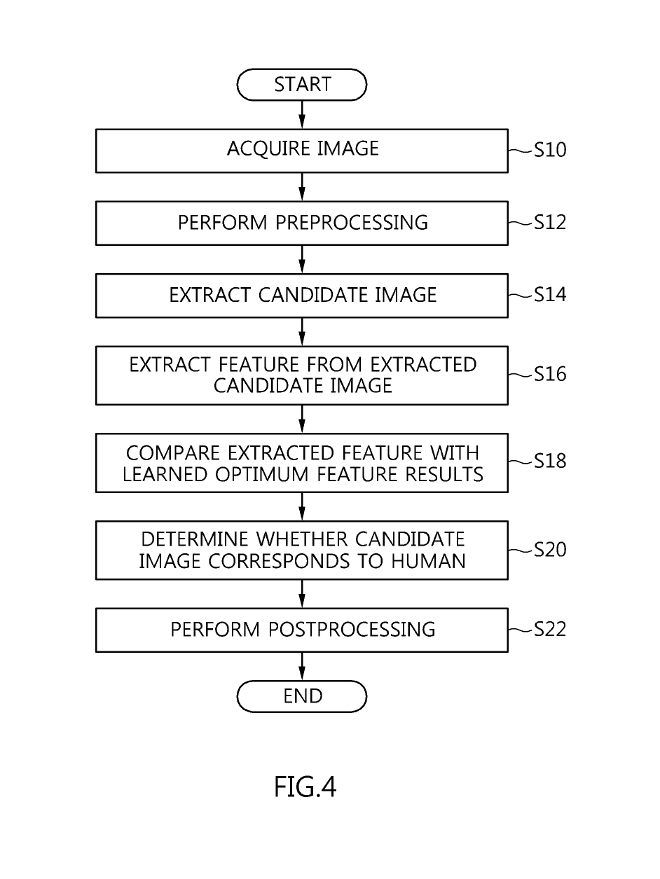

FIG. 4 is a flowchart illustrating a method of recognizing a human in an image according to an embodiment of the present invention.

First, the image acquisition unit 10 acquires an image used to recognize a human (for example, a digital image) and transfers it to the preprocessing unit 20 at step S10.

The preprocessing unit 20 performs preprocessing, such as the elimination of noise from the received image, conversion into a unified image format, and the adjustment of the size of the image at a specific rate, at step S12. The image preprocessed by the preprocessing unit 20 is transmitted to the human recognition unit 40.

Thereafter, the human recognition unit 40 extracts an image of a candidate region (that is, a candidate image) where a human may be present from the input image at step S14.

The human recognition unit 40 then extracts a feature, provided by the learning unit 30 and determined to be an optimum feature, from the extracted candidate image at step S16.

The human recognition unit 40 then compares the feature of the extracted candidate image with an optimum feature learned and determined by the learning unit 30 at step S18.

The human recognition unit 40 then determines whether the candidate image corresponds to a human using the results of the comparison at step S20. For example, the human recognition unit 40 may determine the candidate image not to correspond to a human if a boundary value based on the extraction of the feature of the extracted candidate image is lower than a boundary value calculated by the learning unit 30, and determine the candidate image to correspond to a human if the boundary value based on the extraction of the feature of the extracted candidate image is equal to or higher than the boundary value calculated by the learning unit 30.

Thereafter, the results of the recognition of the human recognition unit 40 are transmitted to the postprocessing unit 50, and the postprocessing unit 50 finally processes the results of the recognition obtained by the human recognition unit 40 so that they are suitable for the purpose at step S22. For example, if the candidate image is determined to correspond to a human, the postprocessing unit 50 calculates the actual location of the human recognized in the original input image while taking into account the rate at which the size of the image was changed by the preprocessing unit 20.

According to the present invention configured as described above, an optimum feature that is more effective in recognizing a human is determined using an optimum boundary value calculated by applying an SVM method to an AdaBoost method, that is, an existing representative optimum feature extraction method, thereby improving the performance of the recognition of a human.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for recognizing a human in an image, comprising:
a learning unit configured to calculate a boundary value between a human and a non-human based on feature candidates extracted from a learning image, to detect a feature candidate for which an error is minimized as the learning image is divided into the human and the non-human using the calculated boundary value, and to determine the detected feature candidate to be a feature; and
a human recognition unit configured to extract a candidate image where a human may be present from an acquired image, and to determine whether the candidate image corresponds to a human based on the feature that is determined by the learning unit.

2. The apparatus of claim 1, wherein the learning unit comprises:
a feature candidate extraction unit configured to extract the feature candidates that can be represented by the feature of the human from the learning image;
a boundary value calculation unit configured to calculate the boundary value that can divide the learning image into a human and a non-human based on the extracted feature candidates;
a minimum error detection unit configured to detect the feature candidate for which the error is minimized as the learning image is divided into the human and the non-human using the calculated boundary value, among the feature candidates; and
a feature determination unit configured to determine the detected feature candidate to be the feature.

3. The apparatus of claim 2, wherein the learning unit further comprises a weight change unit configured to change a weight while taking into account an error of each of the feature candidates that is calculated by the minimum error detection unit.

4. The apparatus of claim 3, wherein the learning unit, if the weights of the feature candidates are changed by the weight change unit, searches again for a feature candidate for which an error is minimized based on the changed weights, and determines this feature candidate to be the feature.

5. The apparatus of claim 1, wherein the human recognition unit comprises:
a candidate image extraction unit configured to extract a candidate image of a region where a human may be present from the acquired image;
a feature extraction unit configured to extract a feature from the extracted candidate image;
a feature comparison unit configured to compare the feature extracted from the candidate image with the feature determined by the learning unit; and
a determination unit configured to determine whether the extracted candidate image corresponds to a human based on results of the comparison of the feature comparison unit.

6. The apparatus of claim 1, further comprising a preprocessing unit configured to preprocess the acquired image and to transfer results of the preprocessing to the human recognition unit.

7. The apparatus of claim 1, wherein the acquired image is a digital image.

8. A method of recognizing a human in an image, comprising:
calculating, by a learning unit, a boundary value between a human and a non-human based on feature candidates extracted from a learning image;
detecting, by the learning unit, a feature candidate for which an error is minimized as the learning image is divided into the human and the non-human using the calculated boundary value, and determining, by the learning unit, the detected feature candidate to be a feature;
extracting, by a human recognition unit, a candidate image where a human may be present from an acquired image; and
determining, by the human recognition unit, whether the candidate image corresponds to a human based on the determined feature.

9. The method of claim 8, wherein the calculating the boundary value learning comprises:
extracting the feature candidates that can be represented by the feature of the human from the learning image; and
calculating the boundary value that can divide the learning image into a human and a non-human based on the extracted feature candidates.

10. The method of claim 8, wherein the boundary value is determined using a Support Vector Machine (SVM) method.

11. The method of claim 8, wherein determining whether the candidate image corresponds to a human comprises:
extracting a feature from the extracted candidate image;
comparing the feature extracted from the candidate image with the determined feature of the learning image; and
determining whether the extracted candidate image corresponds to a human based on results of the comparison.

12. The method of claim 8, further comprising preprocessing the acquired image and transferring results of the preprocessing for use in the extraction of the candidate image.

13. The method of claim 8, wherein the acquired image is a digital image.
